(19) United States
(12) Patent Application Publication
(10) Pub. No.: US 2009/0314589 A1
(43) Pub. Date: Dec. 24, 2009

(54) DISC BRAKE, IN PARTICULAR FOR COMMERCIAL VEHICLES

(75) Inventors: Hans-Christian Jungmann, Weinheim (DE); Marcus Keller, Weinheim (DE); Paul Antony, Worms (DE)

Correspondence Address: Schwabe Williamson & Wyatt;PACWEST CENTER, SUITE 1900, 1211 SW FIFTH AVENUE, PORTLAND, OR, 97204, US

(73) Assignee: WABCO RADBREMSEN GMBH, Mannheim (DE)

(21) Appl. No.: 12/278,561

(22) PCT Filed: Jan. 25, 2007
(86) PCT No.: PCT/EP07/00653

§ 371 Date: Jan. 13, 2009

(30) Foreign Application Priority Data
Feb. 6, 2006 (DE) 102006005297.8

(51) Int. Cl. F16D 65/56

(52) U.S. Cl. 188/71.9

(57) ABSTRACT

The invention relates to a disc brake, in particular for commercial vehicles, having a brake calliper, an adjusting device which has an adjusting shaft which extends into a through opening of the brake calliper, and a sealing device for sealing an annular space between the adjusting shaft and an inner wall which delimits the through opening. According to the invention, a holding device which can be attached releasably to the brake calliper is provided for holding the sealing device with regard to the brake calliper in the axial direction of the adjusting shaft.

The invention relates to a disk brake, in particular for commercial vehicles, having

a brake caliper,

an adjusting device which has an adjusting shaft which extends into a through opening of the brake caliper, and

a sealing device for sealing an annular space between the adjusting shaft and an inner wall which delimits the through opening.

Such a disk brake is known, for example from EP 0 834 672 B1.

In the known disc brake, the adjusting shaft is designed in one piece with the adjusting part. The adjusting shaft is necessary in such a disc brake as an adjusting device in order to make it possible, for example for maintenance or repair work, to change the distance between the brake pad and the brake disk and/or to perform brake checks.

The adjusting shaft is coupled with the adjusting device in such a way that, by twisting the adjusting shaft, the adjusting device is actuated in such a manner that the distance between the brake pad and the brake disk changes.

Since the adjusting shaft extends into a through opening of the brake caliper, a sealing system has to be provided which protects the interior of the caliper from environmental influences—such as dirt and humidity. This purpose is served by the above-mentioned sealing device.

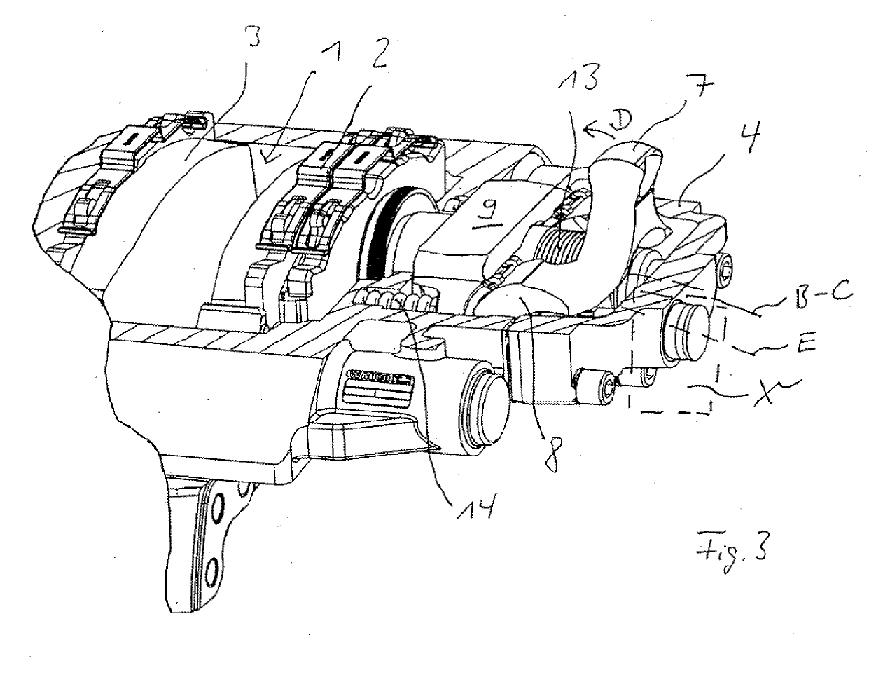

The sealing device in accordance with EP 0 834 672 B1, FIG. 4, is not clearly defined in its installation position, which is why it can disadvantageously move due to brake vibrations. This can lead to a loss of sealing. Moreover, it poses the danger of damage during adjustment work.

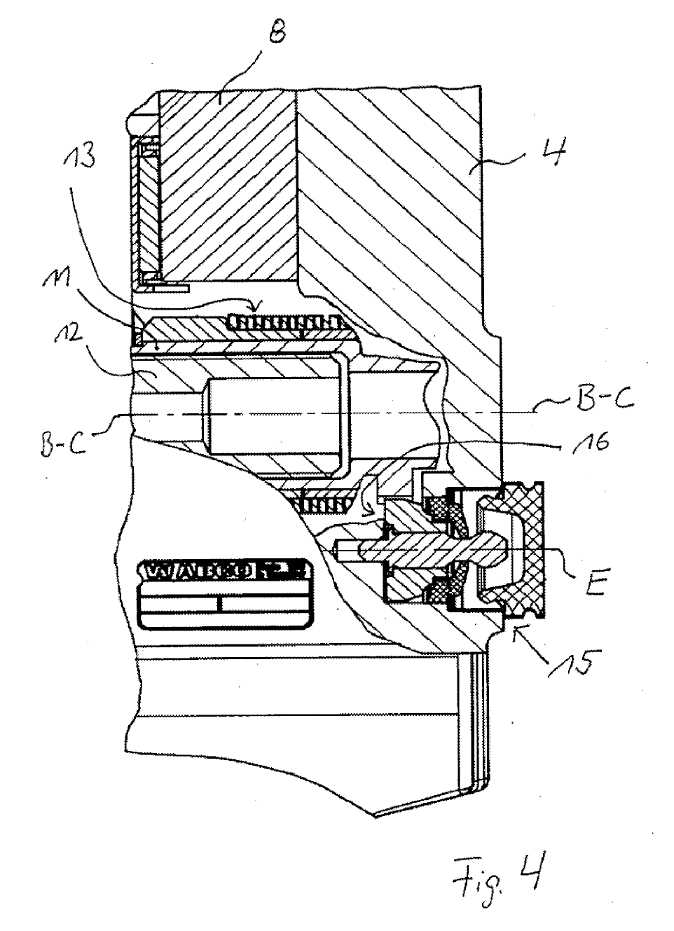

The embodiment in accordance with EP 0 834 672 B1, FIG. 5, poses the additional problem that the sealing device rests against a collar of the caliper, which is why it can only be exchanged if the caliper is removed.

The invention is based on the problem of providing a further development of the disk brake of the type mentioned in the introduction, such that the sealing device is defined in its installation position and that it is ensured that it is capable of being exchanged without removal of the caliper.

According to the invention, this problem is solved for a disk brake of the type mentioned in the introduction by providing a holding device which is capable of being releasably attached to the brake caliper and which serves to hold the sealing device with regard to the brake caliper in the axial direction of the adjusting shaft.

As the holding device holds the sealing device in the axial direction of the adjusting shaft with respect to the brake caliper, the installation position of the sealing device is fixed in the axial direction. However, the sealing device can still be exchanged without removal of the brake caliper because the holding device is capable of being releasably attached to the brake caliper.

In particular, there is no collar or the like required on the brake caliper, which would make such an exchange impossible without removal of the brake caliper.

In accordance with the invention, it is preferred, for reasons of particular mechanical simplicity, that the holding device is designed to be seated in the through opening in the manner of a press fit.

This is because this makes it more easily installable/removable.

In accordance with another preferred embodiment of the invention, a stop is provided on the brake caliper to delimit the holding device in the axial direction of the adjusting shaft and towards the interior of the brake caliper. Such a stop provides for a defined position of the holding device and hence the sealing device especially when the holding device is pushed into the through opening to create the press fit.

In accordance with the invention, the stop is preferably designed such that the through opening increases in size from the inside to the outside. Incidentally, this design contributes to the holding device being removable together with the sealing device in a simple manner, in particular without removal of the brake caliper.

In accordance with the invention, it is preferred that the through opening increases in one or several steps from the inside to the outside. In such an embodiment, the stop can be formed by a surface of a step pointing outwards.

Preferably one, two or more steps are provided.

In accordance with an especially preferred embodiment of the invention, no portion of the through opening lies between the holding device and the stop. This eliminates the danger of the sealing device being crushed between the holding device and the stop.

Based on a further preferred embodiment of the invention, it is provided that the holding device holds the adjusting shaft in the radial direction and/or the axial direction of the adjusting shaft with respect to the brake caliper.

In other words, the holding device in this embodiment serves not only the purpose of holding the sealing device, but also the purpose of determining the installation position of the adjusting shaft, namely in the radial and/or axial direction. This multipurpose property of the holding device results in a reduction of the number of parts.

Preferably, no part of the sealing device is positioned between the holding device and the adjusting shaft. Again, the result of this is that one does not have to worry about the sealing device being crushed between the holding device and the adjusting shaft, especially in the case where the holding device holds the adjusting shaft.

In accordance with an especially preferred embodiment of the invention, it is provided that the adjusting device exhibits a spindle drive and the axis of rotation of the adjusting shaft is parallel to the axis of rotation of the spindle drive. This makes the coupling of the adjusting shaft with the spindle drive particularly simple. This is because no directional change of the rotational movements is necessary during the adjustment.

In accordance with the invention, it is furthermore preferred that the adjusting device exhibits a spindle drive and that the axis of rotation of the adjusting shaft does not coincide with the axis of rotation of the spindle drive. In this embodiment, especially when the axis of rotation of the adjusting shaft is parallel to the rotational shaft of the spindle drive, it is possible to keep the available space behind the spindle drive, as seen from the disk brake, clear, for example for an application shaft, a sensor device or an actuation cylinder.

It is preferred that the holding device tapers towards the inside of the brake caliper. This makes it especially easy to install by pushing it into the through opening.

In accordance with the invention, it is preferred that the holding device is designed to hold a closing device. In other words, the holding device in accordance with this embodiment is assigned a further purpose, which simplifies the overall construction.

In accordance with the invention, it is preferred that the sealing device is permanently attached to the holding device. In this way, the sealing device and the holding device together form an assembly which is capable of being installed and removed in one operation, which reduces the installation/removal effort.

The sealing device can be molded to the holding device, preferably by vulcanizing. The effect of this is considerable freedom in the design of both the holding device and the sealing device.

In accordance with the invention, the sealing device exhibits at least one sealing lip to rest on the adjusting shaft.

Furthermore, it exhibits at least one sealing lip, fluting or a bead for placement against the inner wall of the through opening.

Such devices improve the sealing function with minimum space requirements. They can have a redundant design.

The adjusting shaft may be coupled directly to the adjusting device or its spindle drive. But it can also be provided that the adjusting shaft is non-rotatably connected to a gear device for the coupling with the adjusting device. This creates the possibility of allowing for different materials for the adjusting shaft, on the one hand, and for the gear device, on the other hand, which makes it possible, above all, to realize cost advantages while ensuring the operational capability.

In accordance with a preferred embodiment of the invention, the disk brake exhibits an application shaft positioned parallel to the plane of the brake disk.

In a further preferred embodiment of the invention, the disk brake exhibits a thrust piece extending parallel to the plane of the brake disk, which is pushed from the application shaft against at least one brake pad for application of the brake. This thrust piece hereby serves to equally distribute the braking force on the brake pad or brake pads, specifically to avoid oblique wear.

In the following, the invention is explained in more detail with reference to the attached drawing. In the drawing

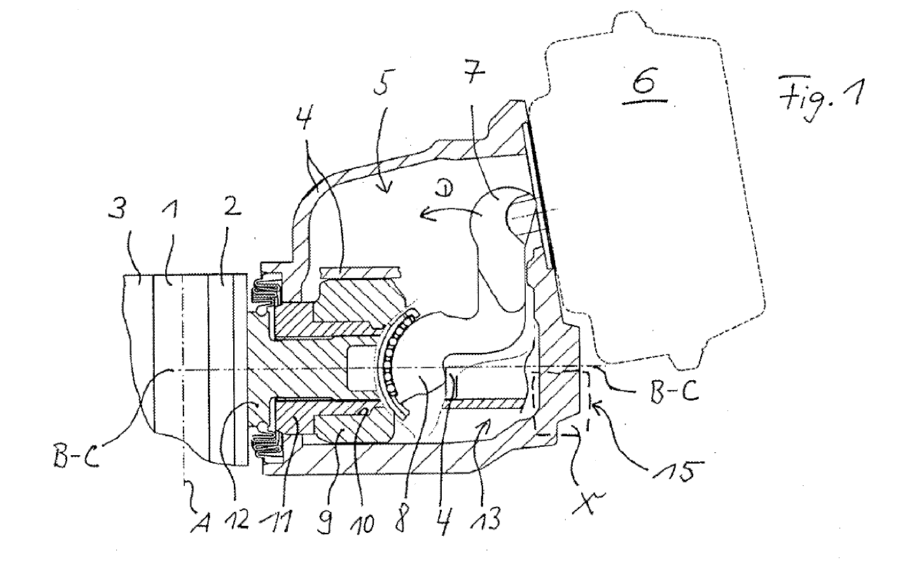

FIG. 1 shows a partial sectional side view of an embodiment of the disk brake in accordance with the invention,

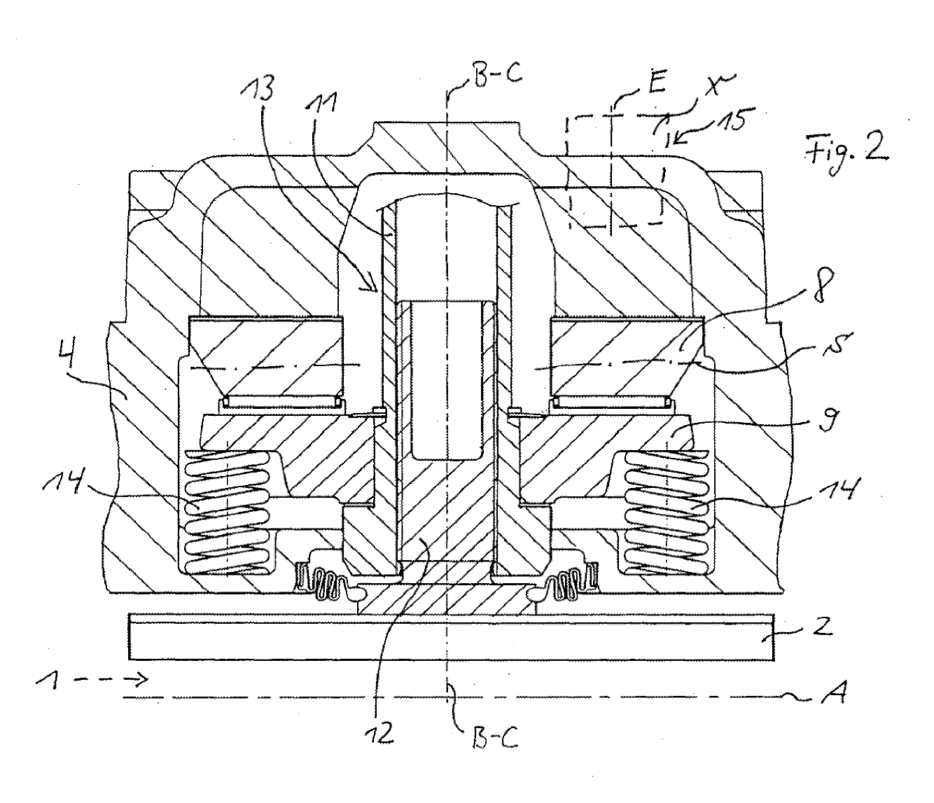

FIG. 2 shows a partial sectional top view of the brake in accordance with FIG. 1,

FIG. 3 shows a perspective view of the brake in accordance with FIG. 1,

FIG. 4 shows a partial sectional detail view of the brake in accordance with FIG. 1,

FIG. 5 shows an explosive view of an adjusting device with associated additional components of the brake in accordance with FIG. 1,

FIG. 6 shows the same parts as in FIG. 5, but in the assembled state,

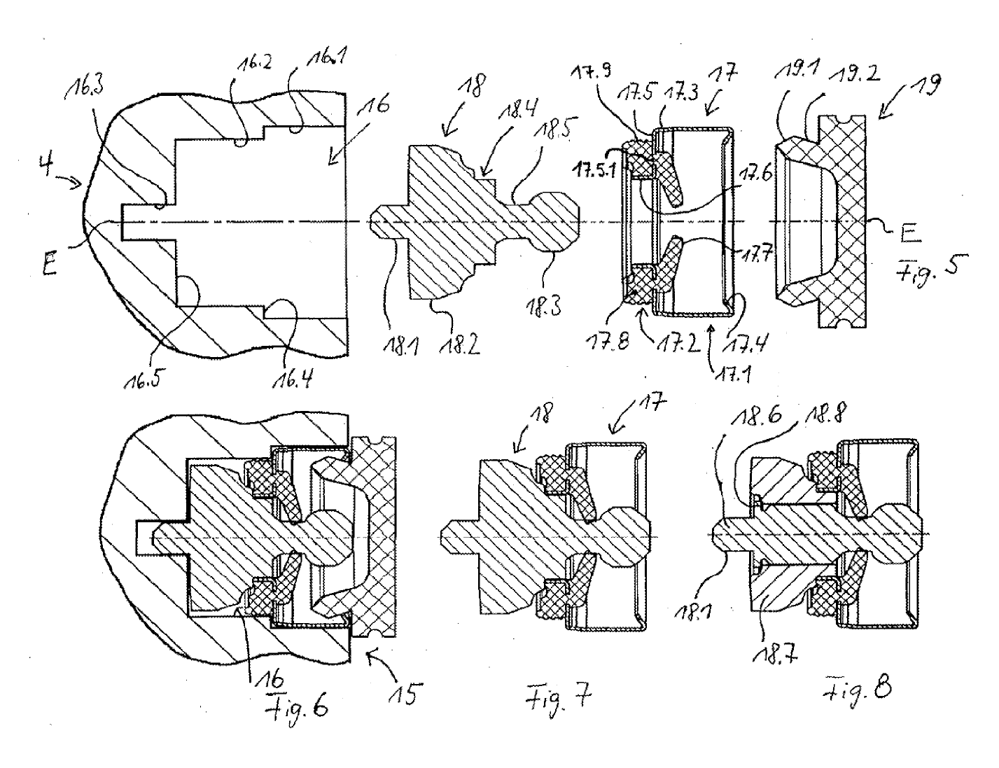

FIG. 7 shows the individual components from FIG. 5 in the assembled state, and

FIG. 8 is the same view as FIG. 7, but of a different embodiment.

The FIGS. 1 to 3 show various views of an embodiment of the disk brake in accordance with the invention, with a rectangle X indicating the position of an adjustment device 15. Further details of the adjustment device can be gathered from FIGS. 4 to 8.

The drawing shows a brake disk 1 with a brake disk plane A, two brake pads 2, 3 and a brake caliper 4 spanning the brake disk 1. A application device is designated by the reference number 5. An actuation cylinder 6 serves to actuate the brake. Above the actuation cylinder 6, which, for example, may be operated pneumatically, a rotary lever 7 is turned around an axis of rotation S for applying force in the direction of the arrow D. An application shaft 8, which is designed in one piece with the rotary lever 7 and which is supported by the brake caliper 4 on the side facing away from the brake disk and by a movably supported thrust piece 9 on the side facing the brake disk, is thereby turned as well.

In a through opening 10, the thrust piece 9 holds a lock nut 11, which in turn is screwed onto a pressure spindle 12. The lock nut 11 and the pressure spindle 12 together form a spindle drive for the adjustment of the brake. The axis of rotation or axis of movement of the spindle drive 11, 12 is referred to as B-C. The reference number 13 designates the entire adjusting device. A pressure spring 14 serves to reset the brake following the application of force.

It should be specifically emphasized that both the form of the cams of the camshaft 8 and their bearing in the brake caliper 4 may deviate from the form shown in the drawing.

The thrust piece 9 has an approximately rectangular shape. It serves to distribute the force exerted during the application of force as equally as possible on the brake pad 2, in order to avoid oblique wear. The same applies to the spindle drive, which can also be designed in any form, using a one- or two-spindle design.

In the following, reference is being made to FIGS. 5 to 8. In these figures, the caliper 4 exhibits a stepped through opening 16, which is sealed by means of a sealing system 17. An adjusting shaft 18 extends into the through opening 16. A sealing plug is designated by the reference number 19.

The leftmost portion of FIG. 5 shows a doubly graded through opening 16 with the bearing areas 16.1, 16.2 and 16.3, with the graduation from large to small forming the contact surfaces 16.4 and 16.5 as seen in the axial direction.

In the embodiment of the invention shown in the drawing, the adjusting shaft 18 is also designed in a stepwise fashion. It displays a peg area 18.1 adjoining to the bearing area 16.3, a gearwheel area 18.2, which engages with the adjusting device 13 (FIG. 4), as well as a multi-sided head 18.3 arranged at the end, which allows the application of a complementary tool for adjustment operations (turning). A standard tool for initiating turning motions may be applied on the multi-sided head in any angular position.

Between the gearwheel area 18.2 (it goes without saying that other transmission types are possible as well) and the multi-sided head 18.3, graded areas 18.4 and 18.5 that are reduced in diameter are provided in the embodiment of the invention shown in the drawing. As can be seen especially in the FIGS. 6, 7 and 8, the area 18.4 specifically forms both a radial and an axial bearing for the sealing system 17, which is described in the following. The same applies to the lateral surface of the area 18.5.

The adjusting shaft 18 is capable of being turned around an axis of rotation E for adjustment purposes. The axis of rotation E is parallel to the axis of rotation B-C of the spindle drive 11, 12, but does not coincide with it. This causes the adjusting device 15 not to be positioned in the area of the disk brake behind the lock nut 11, as seen from the brake disk 1, so that this area can be used for other things, for example a sensor device.

In the embodiment of the invention shown in the drawing, the sealing system 17 consists of two parts made from different materials, i. e. a metal shell 17.1 and a sealing 17.2 made from an elastomer (for example, rubber). Several sealing areas arranged in succession are provided. In other words, the sealing is redundant.

Since the shell 17.1 is made from metal, it is unsusceptible to deformation while being pressed into the brake caliper 4. In the embodiment of the invention shown in the drawing, the shell 17.1 is slightly tapered towards the interior of the caliper, which makes it easier to be pressed into and positioned in the bearing area 16.1. At its outer end, the shell 17.1 exhibits a holding collar 17.4 (hook-shaped due to flanging) extending obliquely towards the interior, which is why the sealing plug 19 is capable of being easily and captively pressed into the shell 17 via the pressing and holding slopes 19.1, 19.2. Therefore the sealing plug 19 is not held on the brake caliper 4 itself, but on the shell 17.1. The shell 17.1 can also have a multi-part design.

At its end facing the interior of the brake, the shell 17.1 exhibits a collar area 17.5, which forms a step and bears a tubular projection 17.6. The collar area 17.5 and the tubular projection 17.6 have several functions. For one, they serve the purpose of the molding/vulcanizing of the actual seal 17.2. For this purpose, several through openings are provided in the collar area 17.5, through which the seal 17.2 penetrates into the collar area 17.5. One such through opening is designated by the reference number 17.5.1. In addition, the collar area 17.5, together with the contact surface 16.4, serves as an axial stop when the sealing system 17 is pressed into the through opening 16 of the brake caliper 4. This serves to establish the sealing system 17 and hence especially the seal 17.2 in the axial direction. Furthermore, the tubular projection 17.6 forms both a radial and an axial bearing for the adjusting shaft 18, because the adjusting shaft 18 is supported radially/axially by the projection 17.6 in its area 18.4. In this way, the shell 17.1, which is pressed into the through opening 16 and which rests against the contact area 16.4, also defines the installation position of the adjusting shaft.

The distance between the contact surfaces 16.4 and 16.5 is defined or dimensioned such that jamming or wedging of the adjusting shaft 18 is eliminated and its flawless rotatability is ensured.

The (actual) seal 17.2 extends on both sides of the collar area 17.5.

This causes the formation of a circular sealing lip 17.7, facing radially inwards, whose inner diameter is slightly smaller than the diameter of the area 18.5 of the adjusting shaft 18, which is why the sealing lip 17.7 rests against the area 18.5 with pre-tension in the mounted state. The area 18.5 may have a tapered design, causing the sealing lip 17.7 to position automatically during the installation. In the area of the projection 17.6, the seal 17.2 is designed in the form of a sealing ring 17.8, whose diameter is equivalent to that of the bearing area 16.2. The outer perimeter of the sealing ring 17.8 exhibits the flutings 17.9, which increases the sealing effect due to, again, the existence of redundant sealing.

A special advantage is derived from the position of the sealing ring 17.8. As it is comparatively far away from the multi-sided head 18.3, there is no danger of damage when a tool is applied to the multi-sided head 18.3 in order to turn the adjusting shaft 18.

FIG. 8 shows a two-part design of the adjusting shaft 18, with an inner body 18.6 and a gearwheel body 18.7. Apart from that, the adjusting shaft 18.6, 18.7 does not differ from the adjusting shaft 18 in accordance with FIGS. 5 to 7. The advantage of the multi-part design (here: two parts) consists in the simplified manufacture, for different materials and/or premanufactured parts may be used. For example, the inner body 18.6 may be made from a profile material e.g. of increased strength, whereas the gearwheel body 18.7 may be made from a material of e.g. lower strength. But in order for the axial positions of the two bodies to be suitable relative to each other, a stop has been provided on the inner body 18.6, in this case having the design of a radial collar 18.8, with the gearwheel body 18.7 resting against this stop.

As can be seen especially in FIG. 5, the contours of the caliper opening 16 and the dimensions of the sealing system 17 as well as the adjusting shaft 18 are matched with each other in such a way that precise installation/sealing positions are defined, as shown specifically in FIGS. 4 and 6. The above-named individual parts can either be installed one after the other and pushed into each other through the through opening 16, as shown in FIG. 5, or they can be installed as a pre-assembled unit in accordance with FIG. 7 or 8. If a partial or complete removal of the adjusting device 15 is required, this can be effected in reverse in a very simple manner as well since no other parts of the brake obstruct this process and therefore no (additional) removals are necessary.

When the adjusting device 15 is completely installed and sealed off by the sealing plug 19, no adjusting part protrudes over the contour of the brake caliper 4. Both the adjusting parts and the inner space of the brake caliper 4 are multiply (redundantly) protected from external influences. Here, the plug 19 and the circular sealing lip 17.7, the shell 17.1, made from stainless and/or coated material, form a multitude of seals at the opening areas and contact areas with their radial and axial sealing areas, so that a sufficient sealing effect is ensured even if one sealing area fails. Thus, the sealing/adjusting system is accessible from the outside without additional holding devices, and it is self-locking and hermetically seals the inner space of the caliper with a redundant sealing system.

Although the invention was described based on a one-spindle brake, it goes without saying that it is also applicable to a two-spindle brake with or without thrust piece. It is also possible for the axes of rotation E and B-C to coincide in the event that the same advantages/effects as described above can be achieved in this way.

The features of the invention disclosed in the above description, the claims as well as the drawing may be essential both individually and in any combination to implement the invention in its various embodiments.

1. Disk brake in particular for commercial vehicles, having a brake caliper (4),
an adjusting device (13), which has an adjusting shaft (18) which extends into a through opening (16) of the brake caliper (4), and
a sealing device (17.2) for sealing an annular space between the adjusting shaft (18) and an inner wall which delimits the through opening (16),
characterized by
a holding device (17.1), capable of being releasably attached to the brake caliper (4), to hod the sealing device (17.2) with regard to the brake caliper (4) in the axial direction of the adjusting shaft (18).

2. Disk brake in accordance with claim 1, characterized in that the holding device (17.1) is designed to be seated in the through opening (16) in the manner of a press fit.

3. Disk brake in accordance with claim 1, characterized by a stop (16.4) on the brake caliper (4) serving to limit a movement of the holding device (17.1) in the axial direction of the adjusting shaft (18) and towards the inside of the brake caliper (4).

4. Disk brake in accordance with claim 3, characterized in that the stop (16.4) is formed by the through opening (16) increasing from the inside to the outside.

5. Disk brake in accordance with claim 4, characterized in that the through opening (16) increases in one or several steps from the inside to the outside.

6. Disk brake in accordance with claim 5, characterized by one, two or more steps.

7. Disk brake in accordance with claim 3, characterized in that no part of the sealing device (17.2) is positioned between the holding device (17.1) and the stop (16.4).

8. Disk brake in accordance with claim 1, characterized in that the holding device (17.1) holds the adjusting shaft (18) in the radial direction and/or the axial direction of the adjusting shaft (18) in relation to the brake caliper (4).

9. Disk brake in accordance with claim 1, characterized in that no part of the sealing device (17.2) is between the holding device (17.1) and the adjusting shaft (18).

10. Disk brake in accordance with claim 1, characterized in that the adjusting device (13) exhibits a spindle drive (11, 12) and the axis of rotation (E) of the adjusting shaft (18) is parallel to the axis of rotation (B-C) of the spindle drive (11, 12).

11. Disk brake in accordance with claim 1, characterized in that the adjusting device (13) exhibits a spindle drive (11, 12) and the axis of rotation (E) of the adjusting shaft (18) does not coincide with the axis of rotation (B-C) of the spindle drive (11, 12).

12. Disk brake in accordance with claim 1, characterized in that the holding device (17.1) is slightly tapered towards the inside of the brake caliper (4).

13. Disk brake in accordance with claim 1, characterized in that the holding device (17.1) is designed to hold a closing device (19).

14. Disk brake in accordance with claim 1, characterized in that the sealing device (17.2) is permanently attached to the holding device (17.1).

15. Disk brake in accordance with claim 1, characterized in that the sealing device (17.2) is molded to the holding device (17.1), preferably by vulcanizing.

16. Disk brake in accordance with claim 1, characterized in that the sealing device (17.2) exhibits at least one sealing lip (17.7) to rest against the adjusting shaft (18).

17. Disk brake in accordance with claim 1, characterized in that the sealing device (17.2) exhibits at least a sealing lip, fluting (17.9) or a bead for placement against the inner wall (16.2) of the through opening (16).

18. Disk brake in accordance with claim 1, characterized in that the adjusting shaft (18) is non-rotatably connected to a gear device (18.7) for coupling with the adjusting device (13).

19. Disk brake in accordance with claim 1, characterized by an application shaft (8) positioned parallel to the brake disk plane (A).

20. Disk brake in accordance with claim 19, characterized by a thrust piece (9) extending parallel to the brake disk plane (A), which is pressed against at least one brake pad (2) to apply force to the brake from the application shaft (8).
